(19) United States
(12) Patent Application Publication
(10) Pub. No.: US 2017/0140133 A1
(43) Pub. Date: May 18, 2017

(54) SYSTEM AND METHOD TO DETERMINE GEOGRAPHIC REGION PROPERTIES OF USERS FOR MEDIA SERVICES

(71) Applicants: Yangbin Wang, Palo Alto, CA (US); WEI LU, Cupertino, CA (US)

(72) Inventors: Yangbin Wang, Palo Alto, CA (US); WEI LU, Cupertino, CA (US)

(21) Appl. No.: 15/344,550

(22) Filed: Nov. 6, 2016

Related U.S. Application Data
(60) Provisional application No. 62/255,154, filed on Nov. 13, 2015.

(51) Int. Cl. G06F 21/12; H04W 64/00

(52) U.S. Cl. CPC G06F 21/123; H04W 64/003; H04W 80/04

(57) ABSTRACT

This invention relates to innovative method and system based on Device DNA to determine geographic region properties of a media user which will not be masked through proxy or virtual private network (VPN) for media content delivery through Internet.

### CROSS REFERENCE TO RELATED APPLICATION

This application is based on provisional application No. 62/255,154, filed Nov. 13, 2015, entitled “System and method to determine geographic region properties of users for media services”, which is hereby incorporated by reference herein.

### BACKGROUND OF THE INVENTION

The existing media distribution business is based on predetermined and closely managed Release Windows and Region Control for films, television programs, music and other types of media contents. Most of the Internet or mobile media distribution business are relying on customers' IP (Internet Protocol) address to determine their geographic regions, therefore appropriate copyright management rules and pricing rates for the media contents are applied accordingly.

As well known, IP address can be masked through VPN (Virtual Private Network) or proxy, and so it is a serious problem for media distribution providers such as Netflix, Apple's iTune and Amazon video to be unable to detect users' geographic regions of their services.

Because IP address is not trustable by proxy or VPN, content owners may lose significant revenues in media distribution over Internet or mobile networks. There are too many examples and stories on this issue across the Internet.

### SUMMARY OF THE INVENTION

Traditional geographic lookup is based on IP address check which can be fake or wrong through proxy or VPN. Meanwhile, a paid user may need to enjoy full service no matter he or she travels for business or vacation. Pricing varies over different distribution regions. For example, typically customer pays higher rate to purchase a movie online in U.S.A., but pay cheaper rate in China, for the same media contents.

The present disclosure is based on Device DNA (simply refers to identification or fingerprint) to determine geographic region properties (by Geographic Region Code or called Geo-Code) of a user which will not be masked through proxy or VPN.

Device DNA is a unique code computationally generated for each device based on a number of unique stable and constant properties of this device. One implementation is to use MD5 (Message Digest version 5) hash algorithm, but not limited thereto, to generate the Device DNA unique code.

Every time when a user goes through online authorization process before accessing media services, a user ID (identifier), for example the user's email address, and its associated Device DNA code, along with the device's physical location, which may or may not be available) or geographic region information will be collected and stored in a database with the event's time stamp. The user's geographic region code, similar to a person's permanent residence address, will be computed based on the statistical history of the user's commonly associated devices and their geographic region information. One implementation is to use the most frequent geographic region information as the user's “permanent” geographic region code.

Upon request, the database which stores the user IDs and their geographic region codes will respond to a query by lookup and then provide a user's geographic region code. This geographic region code in turn can be utilized to apply certain copyright management rules and pricing rate associated with media services for such a user.

Device DNA comprises, but not limited to, physical location properties (PLP), timestamp and use frequency with specific calculation algorithms. The calculation algorithms include Lookup check and calculation of values in the aforementioned PLP, timestamp and use frequency, etc. Hence, Device DNA is utilized to help determine the location of users for using the media contents.

The PLP parameters or values can comprise one or many of the following, such as wireless base-station global ID and device ID, GPS (global positioning service) information, mobile IP, country code of the mobile wireless network, networking and transmission ID including channel ID.

User ID can be one or many of the following, such as passport ID, Driver License ID, Residence ID, Account ID, Subscriber ID, Phone number, e-mail address, etc.

The relation matrix between the User IDs and the Device DNAs is established in an UserID/Device DNA Database, wherein content owners or service providers can search the database for authorized use of media contents. One User ID may have multiple Device DNAs, and one Device DNA may be associated with multiple User IDs.

Residence is defined based on Geo-Code in media content services, wherein resident is defined as content user who live in the specific geographic areas most of the time in a year, such as at least 183 days in a year, but can be adjustable or reconfigurable.

The calculation of Device DNA includes lookup check or calculation of certain values in the Device DNA fields, such as PLP, Timestamp (TS) and User Frequency (UF), as set forth above. The calculation can be executed individually or in combination.

Both Device DNA and User ID can be compressed, shortened or selected into compact format, considering specific values or parameters as to the fields defined in the aforementioned Device DNA and User ID.

The detailed descriptions of the present invention are illustrated in the accompanying drawings and figures, and will be further disclosed in the following paragraphs.

The present disclosure comprises three base claims, but not limited to:

Base claim 1: Method to authorize media service of media contents delivery based on geographic region properties of a media user.

Base claim 2: System of User ID database with associated geographic region properties for media services.

Base claim 3: Method to determine the geographic region properties of a media user based on the user's Device DNA.

The details of the aforementioned base claims are described in the accompanying drawings and figures, and the claim details are provided in the enclosed claims document, wherein some key points are emphasized as follows: In base claim 1, the process includes, but not limited thereto: a) login with User ID; b) request Device DNA; c) submit Device DNA; d) submit User ID to database; e) respond with Geographic Region Code (or Geo-Code); f) decision on whether service is permitted or denied.

In base claim 2, the Geographic Region Code is based on the aforementioned Device DNA, picking up the stable or persistent parameters or values for specific User ID, as set forth above. The aforementioned User ID can be shortened, compacted or simplified as principal or supplemental User ID. One User ID can support multiple Device DNAs for multiple services. The aforementioned Device DNA can be compacted or shortened as Compact Device DNA, with some parameters or values to be optional, in order to simplify the system implementation in some applications. One Device DNA can be associated with multiple user IDs.

In base claim 3, there are two calculation methods: Lookup Table check as Method 1 and Calculation of the aforementioned UF, TS with PLP as Method 2, wherein the Method 1 determines the geographic region properties based on specific associated parameters or fields in the aforementioned Device DNA, such as GID, GPS, CC, NID, as set forth in the drawings, in the aforementioned Database of User IDs/Device DNAs, and the Method 2 determines the geographic region properties based on calculation of the aforementioned UF, TS, together with the aforementioned PLP values, wherein the algorithm of calculation is maximal time of service, maximal frequency of use in specific PLP values or fields. Both methods as set forth above are determined individually or in combination.

Residence information is also determined from the aforementioned methods.

The devices presented in the present invention for the aforementioned User IDs include, but not limited thereto, mobile phone, mobile device, mobile computer, mobile tablet, mobile PC (personal computer), desktop computer, laptop, notebook, television, video phone, video player, game player, media player, etc.

The Database presented in the present invention of the aforementioned User ID/Device DNA Database include, but not limited thereto, on-line database, network database, computer server database, shared database, enterprise database, home database, mobile database and private database, etc.

The aforementioned Database is in frequent collection of the user's reliable geographic physical location (Geo-Code) to determine the service region of the media user.

Each time the media service is used by the media user, the aforementioned database collectively determines the geographic properties of a specific User ID.

The Media Service Provider presented in the present invention for the aforementioned Base claim 1 and others include, but not limited thereto, media content owners, content service owner, third-party content provider, third-party content service provider, and any authorized service provider or operator, etc.

The wireless base-station global ID (GID) presented in the present invention for the aforementioned PLP include, but not limited thereto, cellular mobile base station global ID, WLAN (wireless local area network) access point ID, BWA (broadband wireless access) base station global ID, WPAN (wireless personal access network) access point ID, etc.

The Networking/Transmission ID (NID) presented in the present invention for the aforementioned PLP include, but not limited thereto, wireless channel ID in TDMA (time division multiplex access), CDMA (code division multiplex access), OFDMA (orthogonal frequency division multiplex access), etc.

The authorization of media content usage is based on the collection of the aforementioned User ID and Device DNA together with its physical location properties.

To protect media user's privacy, the aforementioned Device DNA can be shortened or simplified to contain coarse location properties, for example, in some situations, GPS data overkills the customer privacy, and so GPS information can be ignored or reduced in the Device DNA.

In addition, media user's usage history in certain geographic locations determines the service rate for the specific median contents. This usage history analysis contains the User ID, Device DNA, PLP, Usage Frequency and Time Stamp, as set forth above. In case most of the usages of the media contents occur in USA, the aforementioned User ID is set to the service rate of USA. This solution can ensure the maximal value for the content providers and content owners.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows the existing method for media content delivery.

FIG. 2 shows the present invention based on Device DNA.

FIG. 3 defines the detailed structure of Device DNA and User ID.

FIG. 4 discloses the method to check media service authorization.

FIG. 5 discloses the system for the Device DNA database.

Like reference numerals refer to like parts throughout the several views of the drawings.

### DESCRIPTION OF THE PREFERRED EMBODIMENT

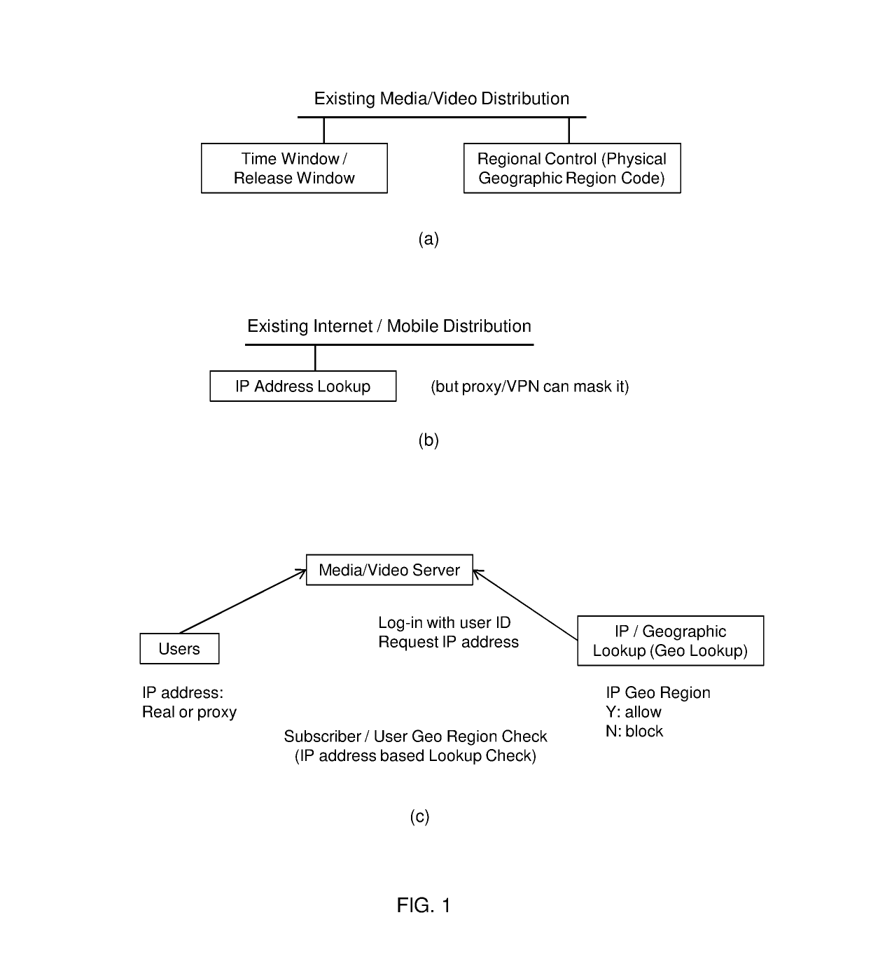

FIG. 1 shows the existing arts on the media distributions or Internet distributions. It is a serious problem for the existing video distributions, for example, Netflix video licensed in U.S. markets with very low effectiveness. The same problems exist for Apple iTune and others.

IP address, generally used by most content owners, is not trustable by proxy or VPN, so content owners lost most of their revenues by Internet users. This is shown in FIGS. 1 (a) and (b).

In FIG. 1(c), traditional geographic (geo) lookup is based on IP address check which can be fake or wrong through proxy or VPN (virtual private network). Meanwhile, a paid customer should enjoy full services no matter he or she is in U.S., China or other countries.

Currently, U.S. customers pay much high rate in U.S., but cheaper rate in China and other countries, for the same media contents. So, some people use fake IP address to try to get the low rate for the same media contents but for the U.S. markets.

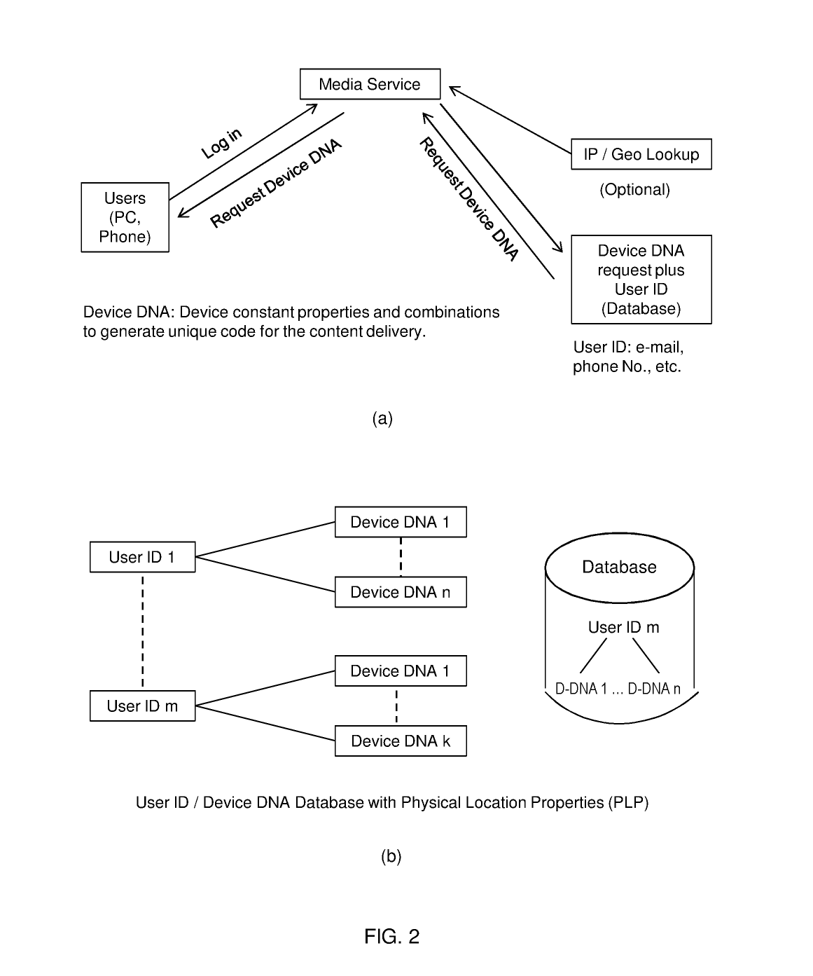

FIG. 2 shows the present invention based on disclosed Device DNA (simply referred to “Identifier” or “Identification”) to calculate geographic properties (Geo-Code) of user IDs and other physical identifications which is impossible to be masked through proxy or VPN.

New Device DNA, a unique geo-code for each user ID, comprises physical location properties (PLP), timestamp (TS), use frequency (UF) and other parameters with calculation algorithms.

The calculation algorithm includes, but not limited to, lookup table check, maximal value of combined calculation of PLP, TS, UF, etc.

The Device DNA contains the constant properties and combinations to generate unique code for the media content delivery, with objective to determine physical location, physical elements, physical attributes, etc of users, plus user information including, but not limited to, ID (identifier), residence and transmission ID, etc.

The Physical Location Properties (PLP) parameters include, but not limited to, wireless base-station Global ID (GID), device ID, GPS (global position service), Mobile IP (Internet Protocol)—MIP of both home and roaming IP, Country Code (CC) of mobile wireless network and Networking/transmission ID (NID), etc.

Device DNA is used to help determine the location of user for using the media contents.

User ID contains, but not limited to, Passport ID, Driver License ID, Residence ID, Account (Holder) ID, Subscriber ID, Phone Number, e-mail address, etc.

The Device DNA (D-DNA) is either in combination or individually calculated. The calculation algorithm includes, but not limited to, Lookup table or maximal value of combination of timestamp (TS), physical location (PLP), frequency of use (UF) and other parameters.

Residence is defined based on the Geo-Code in media content services.

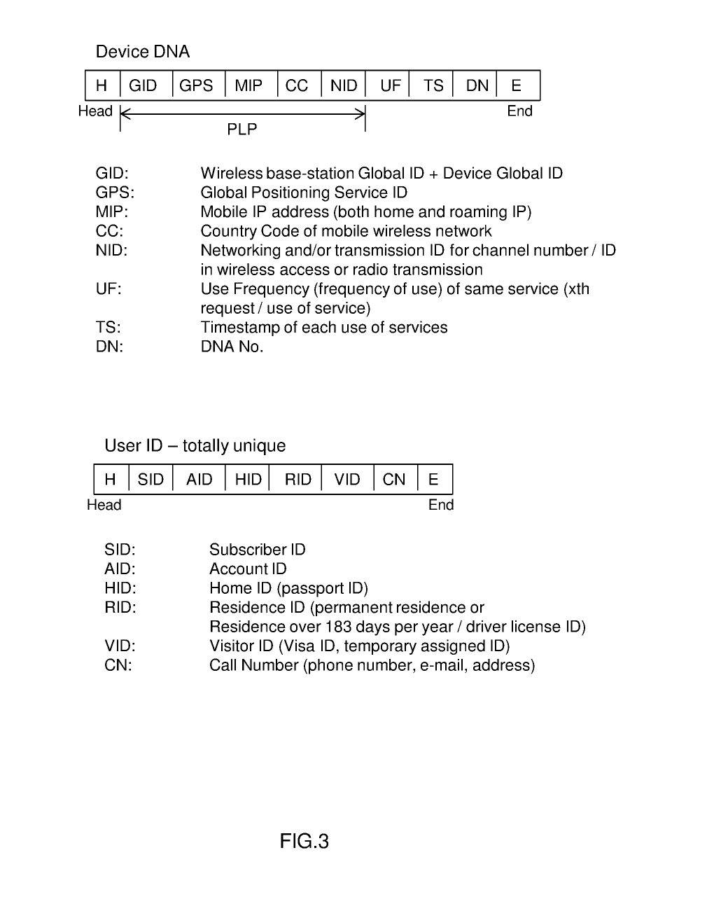

FIG. 3 illustrates the detailed frame structure of the aforementioned Device DNA and the aforementioned User ID.

The Device DNA frame fields are defined with the following parameters:
GID: Wireless base-station Global ID+Device Global ID
GPS: Global Positioning Service ID
MIP: Mobile IP address (both home and roaming IP)
CC: Country Code of mobile wireless network
NID: Networking and/or transmission ID for channel number/ID in wireless access or radio transmission
UF: Use Frequency (frequency of use) of same service (xth request/use of service)
TS: Timestamp of each use of services
DN: DNA No.

The User ID frame fields are defined with the following parameters:
SID: Subscriber ID
AID: Account ID
HID: Home ID (passport ID)
RID: Residence ID (permanent residence or Residence over 183 days per year/driver license ID)
VID: Visitor ID (Visa ID, temporary assigned ID)
CN: Call Number (phone number, e-mail address)

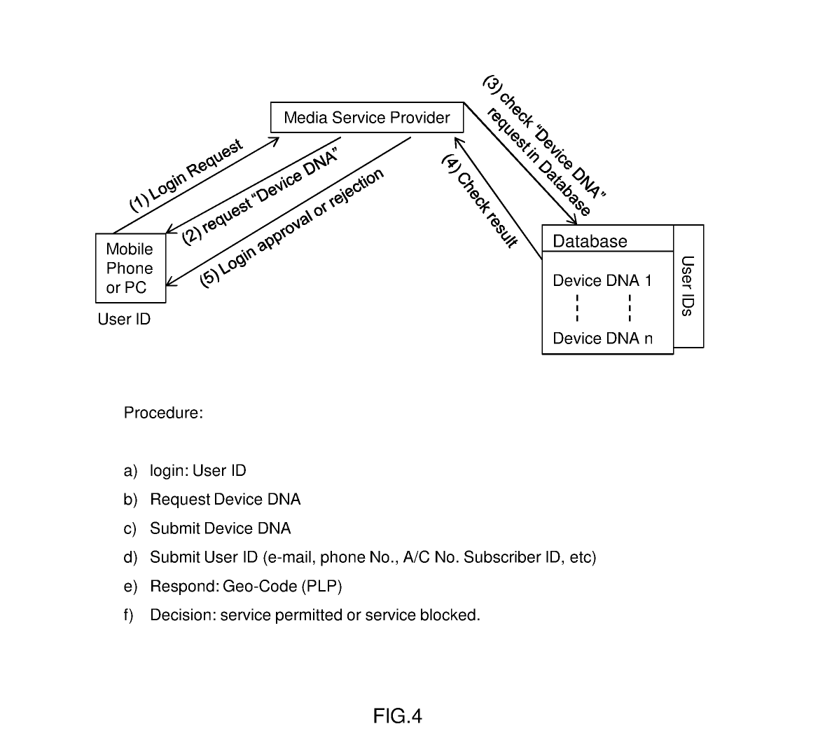

FIG. 4 is the base claim 1 disclosing the method to check if the user is permitted to use the media services or not.

The method comprises the following steps:
a) User, through mobile phone or PC (personal computer), sends Login request with User ID to the Media Service Provider.
b) The Media Service Provider requests Device DNA from the User.
c) The User submits the requested Device DNA to the Media Service Provider.
d) The Media Service Provider checks the submitted Device DNA in Device DNA Database.
e) If the submitted Device DNA matches an DNA in the Database, the Database responds to the Media Service Provider with Geographic region Code (Geo-Code) of the matched DNA, then the Media Service Provider permits the Login request for the User ID.
f) If the submitted Device DNA does not match any DNA in the Database, the Database informs the Media Service Provider which further blocks the Login request for the User ID.
g) For the permitted service of the User ID, the Media Service Provider further utilizes the Geo-Code to check service rate and service package for the media contents.

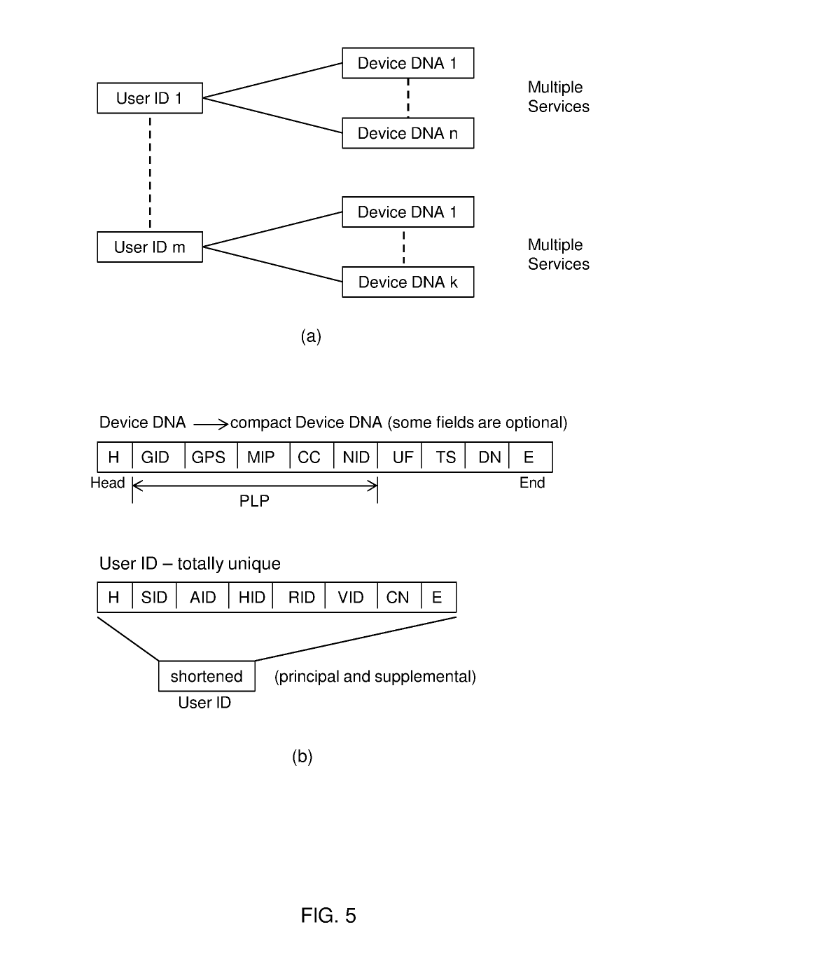

FIG. 5 details the system of the Device DNA database for specific User IDs with multiple services.

The standard Device DNA frame can be shortened or simplified to Compact Device DNA frame to save resource and increase efficiency in the implementation. Some fields in the Device DNA frame are optional in specific applications and implementations to optimize the system performance.

In the same way, the User ID can be shortened or simplified to become principal User ID or supplemental User ID. Some fields in the User ID frame are optional in specific applications and implementations to optimize the system performance.

Geo-Code is based on the Device DNA, picking up the important parameters for the specific User ID.

In summary, the present invention discloses the following details:

A method to authorize media service of media contents delivery based on geographic region properties of a media user comprises:
a) a media user, through media device, sending Login request with User ID (Identifier) to a Media Service Provider,
b) the Media Service Provider requesting Device DNA (simply referring to secured Identification) from the media user,
c) the media user submitting the requested Device DNA to the Media Service Provider,
d) the Media Service Provider checking the submitted Device DNA in Device DNA Database,
e) If the submitted Device DNA matching an DNA in the Database, the Database responding to the Media Service Provider with Geographic region Code (Geo-Code) of the matched DNA, then the Media Service Provider permitting the Login request for the User ID,
f) If the submitted Device DNA not matching any DNA in the Database, the Database informing the Media Service Provider which further blocking the Login request for the User ID, and
g) for permitted service of the User ID, the Media Service Provider further utilizing the Geo-Code to check service rate and service package for the media service of the media contents.

The Geo-Code is based on the Device DNA, picking up important parameters for specific the User ID.

The Geo-Code is Physical Location Properties (PLP) of the Device DNA or extended the PLP to include more parameters of the Device DNA or shortened the PLP to skip some parameters of the Device DNA in different application and service environments.

The Geo-Code is impossible to be masked through proxy or VPN (virtual private network) in IP (Internet Protocol) networks.

The media device includes mobile phone, mobile device, mobile computer, mobile tablet, PC (personal computer), desktop computer, laptop, notebook, television, video phone, video player, game player or media player.

The Database includes on-line database, network database, computer server database, shared database, enterprise database, home database, mobile database or private database.

The Media Service Provider includes media content owner, content service owner, third-party content provider, third-party content service provider, or any authorized service provider or operator of media contents.

The Device DNA refers to secured identification of the media device or fingerprint of the media device.

The media user includes media subscriber, media purchaser or media customer.

The Geo-Code produces the real physically geographic IP address (Geo-IP) for the media user of the User ID.

The Device DNA is a unique code computationally generated for each the media device based on a number of unique stable and constant properties of the media device, wherein one implementation is to use MD5 (Message Digest version 5) or multiple MD5 hash algorithm to generate the Device DNA unique code.

A system of User ID (identifier) and Device DNA (simply referring to secured Identification) database with associated geographic region properties for media service comprises:

an User ID frame including fields of Subscriber ID (SID), Account ID (AID), Home ID (HID such as passport ID), Residence ID (RID such as permanent residence or Residence over 183 days per year/driver license ID), Visitor ID (VID such as Visa ID, temporary assigned ID), Call Number (CN such as phone number, e-mail address), and

an Device DNA frame including fields of Wireless base-station Global ID+Device Global ID (GID), Global Positioning Service ID (GPS or location ID), Mobile IP address (MIP, both home and roaming IP), Country Code of mobile wireless network (CC), Networking and/or transmission ID for channel number/ID in wireless access or radio transmission (NID), Use Frequency of same service (UF), Timestamp of each use of services (TS), DNA Number (DN).

The GID includes cellular mobile base station global ID, WLAN (wireless local area network) access point ID, BWA (broadband wireless access) base station global ID, or WPAN (wireless personal access network) access point ID.

The Device Global ID (GID) includes Device's MAC address and product serial number of device.

The NID includes wireless channel ID in TDMA (time division multiplex access), CDMA (code division multiplex access), or OFDMA (orthogonal frequency division multiplex access).

One User ID corresponds to multiple Device DNAs for multiple media devices by same User ID in the database, and one Device DNA can be shared by multiple User IDs in the database.

A method to determine geographic region properties of a media user for media contents delivery based on user's Device DNA (simply referring to secured Identification) comprises:

Lookup Table Check based on specific associated parameters and fields in the Device DNA including Wireless base-station Global ID+Device Global ID (GID), Global Positioning Service ID (GPS), Mobile IP address (MIP, both home and roaming IP), Country Code of mobile wireless network (CC), Networking and/or transmission ID for channel number/ID in wireless access or radio transmission (NID), referred to as Physical Location Properties (PLP), in database of User IDs (identifiers) and Device DNAs, and/or

Calculation Check based on calculation of Use Frequency of same service (UF), Timestamp of each use of services (TS) together with the PLP values, wherein algorithm of the calculation is based on maximal time of service and maximal number of use in specific the PLP value.

The PLP is used for frequent collection of reliable geographic physical location to determine service region of the media user.

The PLP information can be simplified, shortened or reduced to protect media user's privacy in some situations.

The Geo-Code or PLP is an unique physical code and information based on unique physical wireless base station ID or WLAN access point ID, unique physical wireless networking or transmission channel ID and unique physical GPS data for the media user with the User ID by the media device.

The accompanying drawings are for the purpose of illustration of the invention, without being in a limiting sense.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed:

1. A method to authorize media service of media contents delivery based on geographic region properties of a media user, said method comprising:
a) a media user, through media device, sending Login request with User ID (Identifier) to a Media Service Provider,
b) said Media Service Provider requesting Device DNA (simply referring to secured Identification) from said media user,
c) said media user submitting requested said Device DNA to said Media Service Provider,
d) said Media Service Provider checking submitted said Device DNA in Device DNA Database,
e) If said submitted Device DNA matching an DNA in said Database, said Database responding to said Media Service Provider with Geographic region Code (Geo-Code) of said matched DNA, then said Media Service Provider permitting said Login request for said User ID,
f) If said submitted Device DNA not matching any DNA in said Database, said Database informing said Media Service Provider which further blocking said Login request for said User ID, and
g) for permitted service of said User ID, said Media Service Provider further utilizing said Geo-Code to check service rate and service package for said media service of said media contents.

2. The method as recited in claim 1, wherein said Geo-Code is based on said Device DNA, picking up important parameters for specific said User ID.

3. The method as recited in claim 1, wherein said Geo-Code is Physical Location Properties (PLP) of said Device DNA or extended said PLP to include more parameters of said Device DNA or shortened said PLP to skip some parameters of said Device DNA in different application and service environments.

4. The method as recited in claim 1, wherein said Geo-Code is impossible to be masked through proxy or VPN (virtual private network) in IP (Internet Protocol) networks.

5. The method as recited in claim 1, wherein said media device includes mobile phone, mobile device, mobile computer, mobile tablet, PC (personal computer), desktop computer, laptop, notebook, television, video phone, video player, game player or media player.

6. The method as recited in claim 1, wherein said Database includes on-line database, network database, computer server database, shared database, enterprise database, home database, mobile database or private database.

7. The method as recited in claim 1, wherein said Media Service Provider includes media content owner, content service owner, third-party content provider, third-party content service provider, or any authorized service provider or operator of media contents.

8. The method as recited in claim 1, wherein said Device DNA refers to secured identification of said media device or fingerprint of said media device.

9. The method as recited in claim 1, wherein said media user includes media subscriber, media purchaser or media customer.

10. The method as recited in claim 1, wherein said Geo-Code produces the real physically geographic IP address (Geo-IP) for said media user of said User ID.

11. The method as recited in claim 1, wherein said Device DNA is a unique code computationally generated for each said media device based on a number of unique stable and constant properties of said media device, wherein one implementation is to use MD5 (Message Digest version 5) or multiple MD5 hash algorithm to generate said Device DNA unique code.

12. A system of User ID (identifier) and Device DNA (simply referring to secured Identification) database with associated geographic region properties for media service, said system comprising:
a) an User ID frame including fields of Subscriber ID (SID), Account ID (AID), Home ID (HID such as passport ID), Residence ID (RID such as permanent residence or Residence over 183 days per year/driver license ID), Visitor ID (VID such as Visa ID, temporary assigned ID), Call Number (CN such as phone number, e-mail address), and
b) an Device DNA frame including fields of Wireless base-station Global ID+Device Global ID (GID), Global Positioning Service ID (GPS or location ID), Mobile IP address (MIP, both home and roaming IP), Country Code of mobile wireless network (CC), Networking and/or transmission ID for channel number/ID in wireless access or radio transmission (NID), Use Frequency of same service (UF), Timestamp of each use of services (TS), DNA Number (DN).

13. The system as recited in claim 12, wherein said GID includes cellular mobile base station global ID, WLAN (wireless local area network) access point ID, BWA (broadband wireless access) base station global ID, or WPAN (wireless personal access network) access point ID.

14. The system as recited in claim 12, wherein said Device Global ID (GID) includes Device's MAC address and product serial number of device.

15. The system as recited in claim 12, wherein said NID includes wireless channel ID in TDMA (time division multiplex access), CDMA (code division multiplex access), or OFDMA (orthogonal frequency division multiplex access).

16. The system as recited in claim 12, wherein one said User ID corresponds to multiple said Device DNAs for multiple media devices by same said User ID in said database, and one said Device DNA can be shared by multiple said User IDs in said database.

17. A method to determine geographic region properties of a media user for media contents delivery based on user's Device DNA (simply referring to secured Identification), said method comprising:
a) Lookup Table Check based on specific associated parameters and fields in said Device DNA including Wireless base-station Global ID+Device Global ID (GID), Global Positioning Service ID (GPS), Mobile IP address (MIP, both home and roaming IP), Country Code of mobile wireless network (CC), Networking and/or transmission ID for channel number/ID in wireless access or radio transmission (NID), referred to as Physical Location Properties (PLP), in database of User IDs (identifiers) and Device DNAs, and/or
b) Calculation Check based on calculation of Use Frequency of same service (UF), Timestamp of each use of services (TS) together with said PLP values, wherein algorithm of said calculation is based on maximal time of service and maximal number of use in specific said PLP value.

18. The method as recited in claim 17, wherein both methods are determined individually or in combination.

19. The method as recited in claim 17, wherein said PLP is used for frequent collection of reliable geographic physical location to determine service region of said media user.

20. The method as recited in claim 17, wherein said PLP information can be simplified, shortened or reduced to protect media user's privacy in some situations.
